(19) United States
(12) Patent Application Publication
(10) Pub. No.: US 2013/0089490 A1
(43) Pub. Date: Apr. 11, 2013

(54) METHOD AND DEVICE

(71) Applicants: Wener FILTVEDT, Tomter (NO); Arve Holt, Leirsund (NO)

(72) Inventors: Wener FILTVEDT, Tomter (NO); Arve Holt, Leirsund (NO)

(21) Appl. No.: 13/649,673

(22) Filed: Oct. 11, 2012

Related U.S. Application Data
(60) Provisional application No. 61/545,649, filed on Oct. 11, 2011.

(51) Int. Cl. C01B 33/027; B01J 19/00; B82Y 40/00; B82Y 30/00

(52) U.S. Cl. 423/350; 423/349; 422/198; 977/896; 977/773; 977/900

(57) ABSTRACT

Method for producing nano- to micro-scale particles of a material by homogeneous thermal decomposition or reduction of a reactant gas (12) containing the material, whereby the method comprises the steps of supplying the reactant gas (12) to a reaction chamber (16) of a reactor via at least one inlet, and a) heating the reactant gas (12) to a temperature sufficient for thermal decomposition or reduction of the reactant gas (12) to take place inside the reaction chamber (16), or b) confining a temperature dependent reaction or reaction sequence involving a plurality of reactants inside the reaction chamber (16). The method comprises the step of supplying a primary gas (22) through a porous membrane (20) constituting at least part of at least one wall of the reaction chamber (16) to provide a protective inert gas boundary to minimize or prevent the deposition of the material on the porous membrane (20).

### TECHNICAL FIELD

The present invention concerns a method and device for producing nano- to micro-scale particles of a material, such as silicon, a) by homogeneous thermal decomposition or reduction of a reactant gas containing that material, or b) by confining a temperature dependent reaction or reaction sequence involving a plurality of reactants that decompose upon heating and react with each other inside a reaction chamber.

### BACKGROUND OF THE INVENTION

Chemical vapour deposition (CVD) is a chemical process used to produce high-purity, high-performance solid materials. The process is often used in the electronics, photovoltaic solar, and chemical industry to produce thin films or nano- to micro-scale particles. In a typical CVD process, a substrate (or “wafer”) is exposed to one or more volatile precursors, which react and/or decompose on the substrate surface to produce the desired deposit.

Materials may be deposited in various forms, including: monocrystalline, polycrystalline, amorphous and epitaxial. These materials include: silicon, carbon fibre, carbon nanofibre, carbon nanotubes, SiO₂, silicon-germanium, tungsten, silicon carbide, silicon nitride, silicon oxynitride, titanium nitride and synthetic diamond.

Several applications in which silicon is deposited require pure silicon as feedstock material. The currently dominating technology is the Siemens Reactor, whereby a silicon-containing reactant gas such as monosilane or trichlorosilane is decomposed, which results in the growth of a silicon film on a silicon filament. The walls of the reactor need to be cooled in order to avoid unwanted depositions. The result is severe heat loss. The Siemens reactor produces silicon rods that need to be crushed to chunks before further processing. Such crushing is not only expensive and time consuming but can also present contamination problems.

An alternative process is the Fluidized Bed Reactor where a particle bed is kept fluidized by an ascending gas stream. The reactant gas is heated to decomposition and deposits silicon on the fluidized particles. The product is crystalline spherical silicon beads of 2-5 mm in diameter. A bi-product is the formation of large quantities of silicon fines of varying morphology. For example, U.S. Pat. No. 4,314,525 concerns a process and apparatus for thermally decomposing silicon-containing gas for deposition on fluidized nucleating silicon seed particles. Silicon seed particles are produced in a secondary fluidized reactor by thermal decomposition of a silicon containing gas. The thermally produced silicon seed particles are then introduced into a primary fluidized bed reactor to form a fluidized bed. Silicon containing gas is introduced into the primary reactor where it is thermally decomposed and deposited on the fluidized silicon seed particles. Silicon seed particles having the desired amount of thermally decomposed silicon product thereon are removed from the primary fluidized reactor as an ultra-pure silicon product.

Yet another method is the Free Space Reactor where the reactant gas is heated to decomposition homogeneously in the gas phase. This method needs to be conducted inside a reaction chamber, but the deposition itself occurs favorably at silicon nuclei formed in the gas phase and not on the reactor walls. The most common challenge with this method is unwanted depositions on the inside of the reactor. The product formed is nano- to micro-scale particles of amorphous or crystalline structure, depending on operating conditions. In order to produce large quantities of silicon powder of the desired size and having the desired characteristics it is however necessary to minimize the problem of unwanted wall depositions and control the thermal decomposition or reduction of the reactant gas inside the reaction chamber.

### SUMMARY OF THE INVENTION

An object of the invention is to provide an improved method for producing nano- to micro-scale particles, i.e. a powder or dust having a maximum transverse dimension of up to 100 μm, of a material a) by homogeneous thermal decomposition or reduction of a reactant gas containing the material or b) by confining a temperature dependent reaction or reaction sequence involving a plurality of reactants that decompose upon heating and react with each other.

This object is achieved by a method that comprises the steps of supplying the reactant gas to a reaction chamber of a reactor, such as a one-stage CVD Free Space Reactor, via at least one inlet, and a) heating the reactant gas to a temperature sufficient for thermal decomposition or reduction of the reactant gas to take place inside the reaction chamber or b) confining a temperature dependent reaction or reaction sequence involving a plurality of reactants that decompose upon heating and react with each other inside the reaction chamber. The method also comprises the step of supplying a primary gas through a porous membrane constituting at least part of at least one wall of the reaction chamber to provide a protective inert gas boundary to minimize or prevent the deposition of the material on the porous membrane.

The primary gas may be non-reactive with the material or the reactant gas and/or thermally stable, whereby it does not influence a) the thermal decomposition or reduction of the reactant gas, or b) the temperature dependent reaction or reaction sequence inside the reaction chamber. Alternatively, the primary gas is arranged to influence a) the thermal decomposition or reduction of the reactant gas inside the reaction chamber or b) the temperature dependent reaction or reaction sequence.

According to an embodiment of the invention the method comprises the step of supplying a secondary gas through the porous membrane to influence a) the thermal decomposition or reduction of the reactant gas inside the reaction chamber or b) said temperature dependent reaction or reaction sequence.

Alternatively or additionally, the method comprises the step of supplying a secondary gas to influence a) the thermal decomposition or reduction of the reactant gas inside the reaction chamber or b) the temperature dependent reaction or reaction sequence to the reaction chamber together with the reactant gas.

Large quantities of high purity nano- to micro-sized particles may thereby be produced in a controlled manner since losses due to unwanted wall depositions are minimized or prevented, and the thermal decomposition or reduction of the reactant gas, or the temperature dependent reaction or reaction sequence inside the reaction chamber may be controlled by means of a primary gas and/or a secondary gas. The nano- to micro-sized particles produced using such a method will have a narrow size distribution since the nucleation, growth, morphology and crystallinity of the particles may be controlled by means of the primary gas and/or secondary gas. The method therefore provides a high yield of homogeneous particles whereby no extra step, such as filtering, is required to ensure that a desired standard deviation in size distribution is achieved.

The expression “influence a) the thermal decomposition or reduction of the reactant gas inside the reaction chamber or the temperature dependent reaction or reaction sequence” as used in this document is intended to mean slow down, speed up, prevent, start, modify or change one or more chemical reactions taking place inside the reaction chamber.

The thermal decomposition or reduction of the reactant gas or the temperature dependent reaction or reaction sequence inside the reaction chamber may be influenced by changing at least one of the following characteristics of the primary gas and/or secondary gas: temperature, pressure, flow rate, heat capacity, composition, catalyst type(s) and/or amount(s), and/or concentration of one or more components constituting the secondary gas. By changing at least one of the characteristics of the primary gas and/or secondary gas, the thermal decomposition or reduction of the reactant gas or the temperature dependent reaction or reaction sequence inside the reaction chamber, and consequently the formation and/or growth of particles, and/or their morphology and/or crystallinity, may be controlled in order to obtain a final product having the desired characteristics.

For example, the temperature of the primary gas and/or secondary gas may be increased once particles have been formed in order to produce crystalline material. Alternatively the temperature of the primary gas and/or secondary gas may be decreased to produce amorphous material. The amount of hydrogen in the primary gas and/or secondary gas may be increased to decrease the production of nuclei and thereby the total number of particles. The flow rate of the primary gas and/or secondary gas may be increased to promote turbulence inside the reaction chamber, or decreased to reduce turbulence, depending on which conditions are conducive to the production of the desired product.

The primary gas and/or secondary gas preferably has a high heat capacity to help provide uniform heating within the reaction chamber. This may however vary with the application since several decomposition reactions include intermediate reversible stages, whereby it may be advantageous to promote particle growth over particle formation. Such stages may be temperature dependent and in such cases a controlled uneven temperature distribution is favourable.

The secondary gas may be supplied through the porous membrane simultaneously with the primary gas, periodically, continuously, intermittently, when desired, or in any combination of these ways during the use of a reactor. The primary gas and the secondary gas may be arranged to be supplied through the same pores, or through different pores in the porous membrane.

According to an embodiment of the invention the porous membrane comprises a plurality of pores of different sizes, or of the same size. The porous membrane may comprise a plurality of zones, a zone containing pores of a different size than the pores in an adjacent zone. The maximum transverse dimension of the pores of a porous membrane may be up to 100 nm in order to produce a thin and/or uniform protective gas boundary.

The material may be silicon, carbon fibre, carbon nanofibre, carbon nanotubes, SiO₂, silicon-germanium, a metal such as tungsten, silicon carbide, silicon nitride, silicon oxynitride, titanium nitride, synthetic diamond, or any other material or materials that may be produced by chemical vapour deposition. The material may be deposited in various forms, including: monocrystalline, polycrystalline, amorphous or epitaxial.

According to an embodiment of the invention the material comprises silicon, and the reacting gas comprises silane or a silicon halide for example.

According to another embodiment of the invention the primary gas comprises hydrogen, argon or nitrogen.

It should be noted that the expressions “reactant gas”, “primary gas” and “secondary gas” as used in this document need not necessarily mean that said gases comprise just one type of gas. The primary gas may for example comprises nitrogen only, or nitrogen and one or more other non-reacting gases. A reactant gas, primary gas and/or a secondary gas may also comprise at least one catalyst gas. Furthermore, different primary gases and/or secondary gases may be used during the use of a reactor.

According to a further embodiment of the invention the porous membrane comprises a metal or metal alloy. According to another embodiment of the invention the porous membrane comprises a porous ceramic material including silicon nitride, silicon dioxide or aluminum dioxide. The porous membrane should be inert at the temperatures to which the reactor is subjected during use.

The porous membrane must be constructed to allow the primary gas and optionally a secondary gas to be passed therethrough, whereby the primary has provides a protective boundary adjacent the reaction chamber wall to prevent the contact of the reactant gas and/or said material with the porous membrane. Preferably, the primary gas and optionally the secondary gas are passed through the porous membrane by way of at least one conduit. The primary gas may be arranged to be dispersed uniformly throughout the porous membrane to form a uniform protective gas boundary layer surrounding porous membrane. Optionally, a secondary gas may be arranged to be dispersed uniformly throughout the porous membrane to influence a) the thermal decomposition or reduction of the reactant gas, or b) the temperature dependent reaction or reaction sequence inside the reaction chamber in a uniform manner. The porous membrane must maintain its porous structure at the temperatures to which it will be subjected. It should be noted that the porous membrane may comprise one or more materials. It may for example comprise a fine stainless steel mesh, or an inner structure having a suitable coating.

According to an embodiment of the invention the reactant gas comprises at least one dopant gas.

The present invention also concerns a device for producing nano- to micro-scale particles of a material a) by homogeneous thermal decomposition or reduction of a reactant gas containing the material, or b) by confining a temperature dependent reaction or reaction sequence inside a reaction chamber. The device comprises a reactor, such as a one-stage CVD Free Space Reactor, having a reaction chamber with at least one reactant gas inlet. The device also comprises means, such as heating coils, to heat the reactant gas to a temperature sufficient for a) thermal decomposition or reduction of the reactant gas, or b) the temperature dependent reaction or reaction sequence to take place inside the reaction chamber. The reaction chamber has at least one wall constituted at least in part by a porous membrane, and the device comprises at least one primary gas inlet which is arranged to supply a primary gas through the porous membrane to provide a protective inert gas boundary to minimize or prevent the deposition of the material on the porous membrane when the device is in use.

According to an embodiment of the invention the primary gas is also arranged to influence a) the thermal decomposition or reduction of the reactant gas inside the reaction chamber or b) the temperature dependent reaction or reaction sequence when the device is in use.

According to another embodiment of the invention the device also comprises at least one at least one secondary gas inlet which is arranged to supply a secondary gas through the porous membrane to influence a) the thermal decomposition or reduction of the reactant gas inside the reaction chamber, or b) the temperature dependent reaction or reaction sequence inside the reaction chamber when the device is in use. The primary gas and the secondary gas may pass through the same inlet(s), or via different inlets in the porous membrane.

According to another embodiment of the invention the device comprises at least one secondary gas inlet which is arranged to supply a secondary gas through the porous membrane to influence a) the thermal decomposition or reduction of the reactant gas inside the reaction chamber or b) the temperature dependent reaction or reaction sequence when the device is in use.

Alternatively or additionally the device comprises a secondary gas inlet which is arranged to supply a secondary gas to the reaction chamber together with the reactant gas to influence a) the thermal decomposition or reduction of the reactant gas inside the reaction chamber or b) the temperature dependent reaction or reaction sequence when the device is in use.

The actual dimensions of the components of the device are not especially critical. In addition, operating parameters such as gas flow rates and operating temperatures can be established experimentally for different devices having different sizes and configurations.

The material may be silicon, carbon fibre, carbon nanofibre, carbon nanotubes, SiO₂, silicon-germanium, a metal such as tungsten, silicon carbide, silicon nitride, silicon oxynitride, titanium nitride, synthetic diamond, or any other material or materials that may be produced by chemical vapour deposition. The material may be deposited in various forms, including: monocrystalline, polycrystalline, amorphous or epitaxial.

According to an embodiment of the invention the material comprises silicon, and the reacting gas comprises silane for example.

According to another embodiment of the invention the primary gas comprises hydrogen, argon or nitrogen.

According to a further embodiment of the invention the porous membrane comprises a metal or metal alloy.

According to another embodiment of the invention the porous membrane comprises a porous ceramic material including silicon nitride, silicon dioxide or aluminium dioxide.

According to an embodiment of the invention the porous membrane comprises a plurality of pores of different sizes. According to another embodiment of the invention the porous membrane comprises a plurality of zones, a zone containing pores of a different size than the pores of an adjacent zone. According to a further embodiment of the invention the porous membrane comprises pores having a maximum transverse dimension of up to 100 nm.

According to another embodiment of the invention the reactant gas comprises at least one dopant gas.

### BRIEF DESCRIPTION OF THE DRAWINGS

The present invention will hereinafter be further explained by means of non-limiting examples with reference to the appended figures where;

FIG. 1 shows a device according to an embodiment of the invention, and

FIG. 2 is a flow chart showing the steps of a method according to an embodiment of the invention.

It should be noted that the drawings have not necessarily been drawn to scale and that the dimensions of certain features may have been exaggerated for the sake of clarity.

### DETAILED DESCRIPTION OF EMBODIMENTS

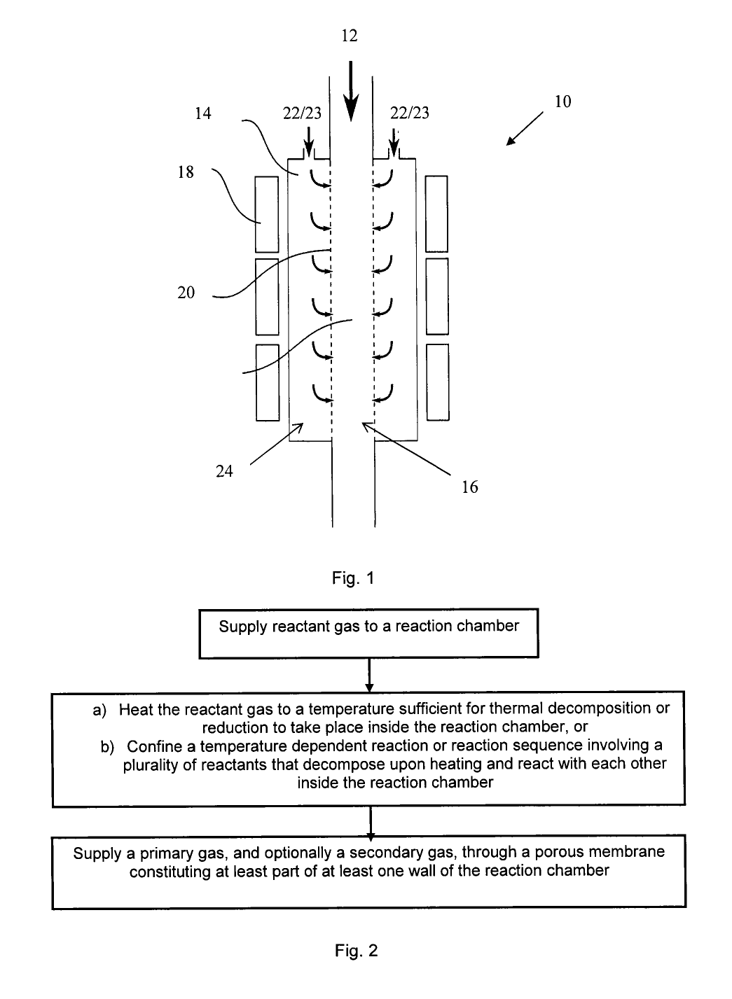

FIG. 1 shows a device 10 for producing nano- to micro-scale particles of a material by homogeneous thermal decomposition or reduction of a reactant gas 12 containing the material. Such a device 10 may be used to carry out a method according to the present invention. The device comprises a reactor 14 having a reaction chamber 16 with one inlet for reactant gas 12, located at the top of the device 10 for example to obtain a descending reactant gas flow. The reactor 14 may be a Free Space Reactor having stainless steel, silicon carbide or quartz walls for example, which is arranged to decompose the reactant gas 12 homogeneously in gas phase and thus to grow nano- to micro-scale particles of the desired material. Volatile by-products are removed by gas flow through the reaction chamber 16. Contrary to the multi-stage reactor disclosed in U.S. Pat. No. 4,314,525, in the device according to the present invention no seed particles are introduced into the reactor 14.

The device 10 also comprises means 18, such as heating coils, which are located around the outer wall of the reactor 14 in the illustrated embodiment, to heat the reactant gas 12 to a temperature sufficient for thermal decomposition or reduction of the reactant gas 12 to take place inside the reaction chamber 16. The reaction chamber 16 in the illustrated embodiment is constituted by a single wall constituted entirely by a porous membrane 20, such as a substantially cylindrical tube of material of suitable mechanical and chemical properties. It should be noted that the porous membrane 20 may be of any suitable shape, it may for example be in the form of an upright or inverted cone. The device 10 also comprises two inlets for primary gas which are arranged to supply a primary gas 22 through the porous membrane 20 to provide a protective inert gas boundary at the wall of the reaction chamber 16 to minimize or prevent the deposition of the material on the porous membrane 20 when the device 10 is in use. The two inlets may also be used to supply a secondary gas 23 through the porous membrane 20 to influence the thermal decomposition or reduction of the reactant gas 12 inside the reaction chamber 16.

For example, a silicon-containing reactant gas 12, such as monosilane (SiH₄), diluted in hydrogen, is supplied to the reaction chamber 16. Means 18 for heating the reaction chamber 16 raises the temperature of the reactant gas 12 to a point of thermal decomposition whereby the following reaction takes place and elemental silicon, which may subsequently be removed from the reaction chamber, is formed:

SiH₄→Si+2H₂

For monosilane this temperature is 400° C. The reactant gas may also contain one or more dopant gases, such as arsine, diborane, phosphine, boron trifluoride, boron-II-trifluoride, trimethylboron or any other metal/organic/inorganic dopant gas. Primary gas 22, such as hydrogen, nitrogen or argon is supplied to a chamber 24 outside the reaction chamber 16 that is delimited by the porous membrane wall 20. The reactor 14 is thereby divided into an outer chamber 24 for primary gas 22 and an inner reaction chamber 16 where a decomposition or reduction reaction takes places at a distance from the wall(s) of the reaction chamber 16. The primary gas 22 in the outer chamber 24 is namely arranged to pass through the porous membrane 20 from the outer chamber 24 to the near wall region of the reaction chamber 16. When the primary gas 22 enters the reaction chamber 16, the near wall region will be kept free of reactant gas 12 and thus unwanted wall depositions will be avoided.

Secondary gas 23 may also be supplied to the chamber 24 outside the reaction chamber 16 that is delimited by the porous membrane wall 20. The secondary gas 23 may be added in the particles' nucleation and/or growth phase(s). The secondary gas 23 may for example contain a lithium-containing gas, which is supplied through the porous membrane during the particle nucleation phase, and/or after the particle nucleation phase but prior to their exposure to air.

Depending on the operation temperature and requirements for the finished product, the porous membrane 20 may comprise a metal alloy such as AISI316, Inconel, 253MA or HT800. The membrane may also be produced from porous sintered silicon-nitride Si₃N₄, porous silica SiO₂, porous alumina Al₂O₃ or any other suitable material.

It should be noted that the reaction chamber dimensions may vary from a cylinder having a diameter of a few centimetres to a few metres.

FIG. 2 is a flow chart showing the steps of a method according to the present invention. The method comprises the steps of supplying reactant gas to a reaction chamber of a reactor, a) heating the reactant gas to a temperature sufficient for thermal decomposition or reduction of the reactant gas to take place, or b) confining a temperature dependent reaction or reaction sequence inside the reaction chamber, and supplying a primary gas through a porous membrane constituting at least part of at least one wall of the reaction chamber to provide a protective inert gas boundary to minimize or prevent the deposition of the material on the porous membrane. The method also comprises the step of supplying a secondary gas through the porous membrane to influence a) the thermal decomposition or reduction of the reactant gas, or b) the temperature dependent reaction or reaction sequence inside the reaction chamber. It should be noted that these steps need not be carried out in sequence. On the contrary an inert gas boundary is preferably, but not necessarily established before reactant gas and/or a secondary gas is supplied to the reaction chamber.

The nano- to micro-scale particles of a material produced in the method according to the present invention may be used for several applications.

Taking silicon powder as an example; a rising new market is feedstock material for lithium ion battery anode material. By using silicon instead of carbon anodes in the lithium batteries, or at least replacing part of the carbon by silicon, it has been shown that the storage capacity can be substantially increased.

Other rising new markets include those using doped silicon particles. These doped silicon particles may be used for local increased carrier density under the contacts of a solar cell (which may be a doped silicon sheet) or other high level industrial processes to increase photovoltaic cell performance.

Another possible market is the direct wafer process. In this process the wafers are produced directly by passing large currents through a thin powder bed and thus directly melt and produce the wafer. In order to produce a functioning solar cell there is an inherent need for making a P-N junction. The common method for making a cell is to have a feedstock material that is either P- or N-doped from the start. This means that the material is deliberately “contaminated” with either atoms having one excess electron, or atoms missing one electron compared to silicon. When these atoms are included in the silicon lattice the excess electron or hole will make a permanent charge in the material. By doping each side of the silicon wafer differently, a permanent charge field is produced and this makes the excited electrons wander distinctly to the contacts and they may thus be collected. If one want to produce these direct wafers there will be need for doping the silicon nanoparticles and this will thus require the injecting of dopant gasses into the reaction chamber.

Further modifications of the invention within the scope of the claims would be apparent to a skilled person.

1. A method for producing nano- to micro-scale particles the method comprising supplying a reactant gas to a reaction chamber of a reactor through at least one inlet, and
a) heating the reactant gas to a temperature sufficient for thermal decomposition or reduction of the reactant gas to occur inside the reaction chamber, or
b) confining a temperature dependent reaction or reaction sequence inside the reaction chamber,
to produce nano- to micro-scale particles of a material,
wherein characterized in that the method further comprises the step of supplying a primary gas through a porous membrane constituting at least part of at least one wall of the reaction chamber to provide a protective inert gas boundary to minimize or prevent the deposition of the material on the porous membrane.

2. The method according to claim 1, wherein the primary gas is also arranged to influence the thermal decomposition or reduction a) of said reactant gas inside the reaction chamber or the temperature dependent reaction or reaction sequence b).

3. The method according to claim 1, wherein the supplying of the secondary gas through the porous membrane influences the thermal decomposition or reduction a) of said reactant gas inside the reaction chamber or the temperature dependent reaction or reaction sequence b).

4. The method according to claim 1, further comprising supplying a secondary gas to influence the thermal decomposition or reduction a) of said reactant gas inside the reaction chamber or the temperature dependent reaction or reaction sequence b) to the reaction chamber together with said reactant gas.

5. The method according to claim 1, wherein the material comprises silicon.

6. The method according to claim 1, wherein the reacting gas comprises a silane.

7. The method according to claim 1, wherein the primary gas comprises hydrogen, argon or nitrogen.

8. The method according to claim 1, wherein the porous membrane comprises a metal or metal alloy.

9. The method according to claim 1, wherein the porous membrane comprises a porous ceramic material comprising silicon nitride, silicon dioxide or aluminum dioxide.

10. The method according to claim 1, wherein the porous membrane comprises a plurality of pores of different sizes.

11. The method according to claim 1, wherein the porous membrane comprises a plurality of zones, said zones comprising pores of a different size than the pores of an adjacent zone.

12. The method according to claim 1, wherein the porous membrane comprises pores having a maximum transverse dimension of up to 100 nm.

13. The method according to claim 1, wherein the primary gas, the secondary gas, or both, comprises a dopant gas.

14. The method according to claim 1, wherein the reactant gas comprises a dopant gas.

15. A device, comprising a reactor comprising a reaction chamber with at least one reactant gas inlet, and
a) a heater to heat the reactant gas to a temperature sufficient for thermal decomposition or reduction of the reactant gas to occur inside the reaction chamberm or
b) a structure to confine a temperature dependent reaction or reaction sequence involving a plurality of reactants inside the reaction chamber,
wherein:
the reaction chamber comprises a wall comprising at least in part a porous membrane, and
the device further comprises a primary gas inlet which is arranged to supply a primary gas through the porous membrane to provide a protective inert gas boundary to minimize or prevent deposition of a material on the porous membrane.

16. The device according to claim 15, wherein the primary gas is arranged to influence the thermal decomposition or reduction a) of said reactant gas inside the reaction chamber or the temperature dependent reaction or reaction sequence b).

17. The device according to claim 15, further comprising a secondary gas inlet which is arranged to supply a secondary gas through the porous membrane to influence the thermal decomposition or reduction a) of said reactant gas inside the reaction chamber or the temperature dependent reaction or reaction sequence b).

18. The device according to claim 15, further comprising a secondary gas inlet which is arranged to supply a secondary gas to the reaction chamber together with said reactant gas to influence the thermal decomposition or reduction a) of said reactant gas inside the reaction chamber or the temperature dependent reaction or reaction sequence b).

19. The device according to claim 15, wherein the material is silicon.

20. The device according to claim 15, wherein the reactant gas comprises silane.

21. The device according to claim 15, wherein the said primary gas comprises hydrogen, argon or nitrogen.

22. The device according to claim 15, wherein the porous membrane comprises a porous metal alloy.

23. The device according to claim 15, wherein the porous membrane comprises a porous ceramic material comprising silicon nitride, silicon dioxide or aluminium dioxide.

24. The device according to claim 15, wherein the said porous membrane comprises a plurality of pores of different sizes.

25. The device according to claim 15, wherein the said porous membrane comprises a plurality of zones, said zones comprising pores of a different size than the pores of an adjacent zone.

26. The device according to claim 15, wherein the porous membrane comprises pores having a maximum transverse dimension of up to 100 nm.

27. The device according to claim 15, wherein the primary gas, the secondary gas, or both, comprises a dopant gas.

28. The device according to claim 15, wherein the reactant gas comprises a dopant gas.
